(19) United States
(12) Patent Application Publication
(10) Pub. No.: US 2015/0078545 A1
(43) Pub. Date: Mar. 19, 2015

(54) SYSTEM AND METHOD FOR PROVIDING AUTOMATED TRUNK SWITCHING FOR QUALITY OF SERVICE IMPROVEMENT

(71) Applicant: Amir Kiai, Irvine, CA (US)

(72) Inventor: Amir Kiai, Irvine, CA (US)

(21) Appl. No.: 14/484,792

(22) Filed: Sep. 12, 2014

Related U.S. Application Data
(60) Provisional application No. 61/877,319, filed on Sep. 13, 2013.

(51) Int. Cl. H04Q 3/00

(52) U.S. Cl. CPC H04Q 3/0016
USPC 379/221.01

(57) ABSTRACT

The present invention generally relates to voice communication means and systems for provision thereof. Specifically, the present invention relates to a computer implemented system and method for providing switching between a plurality of voice networks, or trunks, based at least in part on the quality of service (QoS) of a trunk.

### CROSS REFERENCE TO RELATED APPLICATIONS

This application claims the benefit of U.S. Provisional Patent Application No. 61/877,319 filed Sep. 13, 2013 and entitled “System and Method for Providing Automated Trunk Switching for Quality of Service Improvement” the entire disclosure of which is incorporated herein by reference.

### FIELD OF THE INVENTION

The present invention generally relates to voice communication means and systems for provision thereof. Specifically, the present invention relates to a computer implemented system and method for providing switching between a plurality of voice networks, or trunks, based at least in part on the quality of service (QoS) of a trunk.

### BACKGROUND OF THE INVENTION

One of the most important properties of any voice communication system is the quality of service that system provides. In particular, the quality of a given a phone call is an important factor for users of a voice communication system, as call quality is the factor that a user is most likely to use in evaluating their overall satisfaction with a given voice communication system. Currently available voice communication systems utilize multiple call trunks to facilitate the phone calls that the users of the system make, but like any other system or service, there are instances when a given call trunk of voice communication system may not provide optimal levels of service. A major drawback of currently available voice communication systems is that those systems do not enable a user to switch between call trunks to utilize the call trunk that will provide the highest quality of service and instead require a user to i) continue using the same call trunk or ii) seek out customer and/or technical support in order to ask the service provider to change the user's call trunk settings.

Therefore, there is a need in the art for a voice communications system that allows a user to switch between available call trunks to improve the quality of service on a given phone call without requiring manual resetting by technical support. These and other features and advantages of the present invention will be explained and will become obvious to one skilled in the art through the summary of the invention that follows.

### SUMMARY OF THE INVENTION

Accordingly, it is an object of the present invention to provide a system and method for switching between call trunks of a voice communication system in order to improve quality of service.

According to an embodiment of the present invention, a system for providing automated trunk switching for quality of service improvement includes: a trunk switching module, comprising computer-executable code stored in non-volatile memory, a processor, and a communication means, wherein said trunk switching module, said processor, and said communication means are operably connected and are configured to: provide access a user with access to a voice communication system, wherein said voice communication system has access to a plurality of call trunks; connect a phone call of a user to a destination number via a first call trunk selected from said plurality of call trunks; receive a call trunk switch command from said user; retrieve a list of available call trunks, wherein said list of available call trunks are others of said plurality of call trunks that are available to transmit said phone call; and connect said user to said destination number via a second call trunk.

According to an embodiment of the present invention, a loopback method is used to retrieve said list of available call trunks and each of said plurality of call trunks are attempted one at a time until arriving back at said first call trunk.

According to an embodiment of the present invention, the trunk switching module, said processor, and said communication means are operably connected and are further configured to: detect said quality of service on each of said plurality of call trunks by monitoring each call trunk for one or more of static and signal strength; determine whether each of said plurality of call trunks is above a quality of service threshold; and upon determining that said quality of service for one of said plurality of call trunks is below said quality of service threshold, excluding each of said plurality of call trunks that are below said quality of service threshold from said list of available call trunks.

According to an embodiment of the present invention, the quality of service for a selected call trunk is detected prior to connecting said phone call to said destination number by connecting to a test phone number using said selected call trunk.

According to an embodiment of the present invention, the trunk switching module, said processor, and said communication means are operably connected and are further configured to record historical quality of service levels for each of said plurality of call trunks to determine a preferred list of call trunks.

According to an embodiment of the present invention, the call trunk switch command is a non-standard tone entered by said user.

According to an embodiment of the present invention, the non-standard tone is selected from a group of non-standard tones comprised of asterisk button tones, hash button tones, and combination tones.

According to an embodiment of the present invention, the call trunk switch command is a voice command.

According to an embodiment of the present invention, the voice command is a non-standard word combination.

According to an embodiment of the present invention, a method for providing automated trunk switching for quality of service improvement includes the steps of: providing access a user with access to a voice communication system, wherein said voice communication system has access to a plurality of call trunks; connecting a phone call of a user to a destination number via a first call trunk selected from said plurality of call trunks; receiving a call trunk switch command from said user; retrieving a list of available call trunks, wherein said list of available call trunks are others of said plurality of call trunks that are available to transmit said phone call; and connecting said user to said destination number via a second call trunk.

According to an embodiment of the present invention, a loopback method is used to retrieve said list of available call trunks and each of said plurality of call trunks are attempted one at a time until arriving back at said first call trunk.

According to an embodiment of the present invention, the method further includes the steps of: detecting said quality of service on each of said plurality of call trunks by monitoring each call trunk for one or more of static and signal strength; determining whether each of said plurality of call trunks is above a quality of service threshold; and upon determining that said quality of service for one of said plurality of call trunks is below said quality of service threshold, excluding each of said plurality of call trunks that are below said quality of service threshold from said list of available call trunks.

According to an embodiment of the present invention, the quality of service for a selected call trunk is detected prior to connecting said phone call to said destination number by connecting to a test phone number using said selected call trunk.

According to an embodiment of the present invention, the method further includes the step of recording historical quality of service levels for each of said plurality of call trunks to determine a preferred list of call trunks.

According to an embodiment of the present invention, the call trunk switch command is a non-standard tone entered by said user.

According to an embodiment of the present invention, the non-standard tone is selected from a group of non-standard tones comprised of asterisk button tones, hash button tones, and combination tones.

According to an embodiment of the present invention, the call trunk switch command is a voice command.

According to an embodiment of the present invention, the voice command is a non-standard word combination.

According to an embodiment of the present invention, a system for providing automated trunk switching for quality of service improvement, said system comprising: a trunk switching module, comprising computer-executable code stored in non-volatile memory, a processor, and a communication means, wherein said trunk switching module, said processor, and said communication means are operably connected and are configured to: provide access a user with access to a voice communication system, wherein said voice communication system has access to a plurality of call trunks; connect a phone call of a user to a destination number via a first call trunk selected from said plurality of call trunks; receive a call trunk switch command from said user; retrieve a list of available call trunks, wherein said list of available call trunks are others of said plurality of call trunks that are available to transmit said phone call; and connect said user to said destination number via a second call trunk.

According to an embodiment of the present invention, a loopback method is used to retrieve said list of available call trunks and each of said plurality of call trunks are attempted one at a time until arriving back at said first call trunk.

According to an embodiment of the present invention, the trunk switching module, processor, and communication means are operably connected and are further configured to: detect said quality of service on each of said plurality of call trunks by monitoring each call trunk for one or more of static and signal strength; determine whether each of said plurality of call trunks is above a quality of service threshold; and upon determining that said quality of service for one of said plurality of call trunks is below said quality of service threshold, excluding each of said plurality of call trunks that are below said quality of service threshold from said list of available call trunks.

According to an embodiment of the present invention, the quality of service for a selected call trunk is detected prior to connecting said phone call to said destination number by connecting to a test phone number using said selected call trunk.

According to an embodiment of the present invention, the trunk switching module, said processor, and said communication means are operably connected and are configured to record historical quality of service levels for each of said plurality of call trunks to determine a preferred list of call trunks.

According to an embodiment of the present invention, the call trunk switch command is a non-standard tone entered by said user.

According to an embodiment of the present invention, the non-standard tone is selected from a group of non-standard tones comprised of asterisk button tones, hash button tones, and combination tones.

According to an embodiment of the present invention, the call trunk switch command is a voice command.

According to an embodiment of the present invention, the voice command is a non-standard word combination.

According to an embodiment of the present invention, a method for providing automated trunk switching for quality of service improvement, said method comprising the steps of: providing access a user with access to a voice communication system, wherein said voice communication system has access to a plurality of call trunks; connecting a phone call of a user to a destination number via a first call trunk selected from said plurality of call trunks; receiving a call trunk switch command from said user; retrieving a list of available call trunks, wherein said list of available call trunks are others of said plurality of call trunks that are available to transmit said phone call; and connecting said user to said destination number via a second call trunk.

According to an embodiment of the present invention, the method further comprises the steps of: detecting said quality of service on each of said plurality of call trunks by monitoring each call trunk for one or more of static and signal strength; determining whether each of said plurality of call trunks is above a quality of service threshold; and upon determining that said quality of service for one of said plurality of call trunks is below said quality of service threshold, excluding each of said plurality of call trunks that are below said quality of service threshold from said list of available call trunks.

According to an embodiment of the present invention, the method further comprises the step of recording historical quality of service levels for each of said plurality of call trunks to determine a preferred list of call trunks.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention; and

FIG. 3 illustrates an exemplary method, in accordance with an embodiment of the present invention.

### DETAILED SPECIFICATION

The present invention generally relates to voice communication means and systems for provision thereof. Specifically, the present invention relates to a computer implemented system and method for providing switching between a plurality of voice networks, or trunks, based at least in part on the quality of service (QoS) of a trunk.

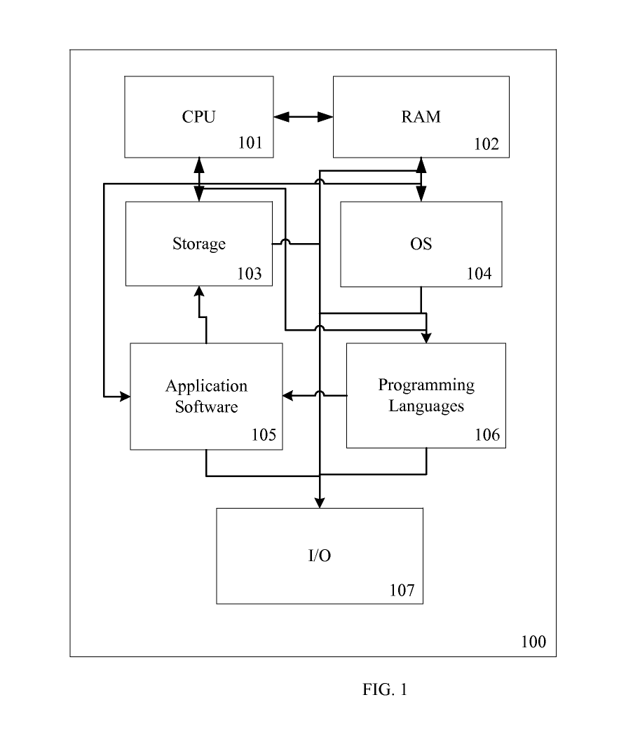

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more programming languages 106 and one or more input/output devices/means 107. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) user uses Phone IVR (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention a user may be able to compose data offline that will be consumed by the system when the user is later connected to a network.

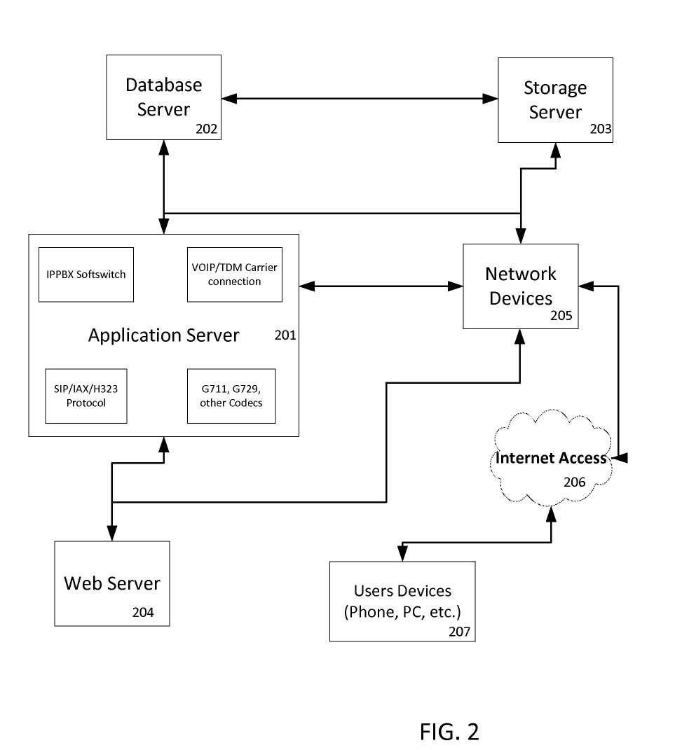

Referring to FIG. 2, a schematic overview of a system in accordance with an embodiment of the present invention is shown. The system is comprised of one or more application servers 201 for electronically processing and storing information used by the system. Applications in the application server 201 may retrieve and manipulate information in local storage devices or with one or more of a database server 202, a storage server 203, and a web server 204 and exchange information through one or more network devices 205 potentially connected to one or more LANs or WANs 206 (e.g., the Internet). In certain embodiments of the present invention, the application server 201 is configured to receive communications from one or more telephony systems via one or more communications means (e.g., IPPBX, VOIP/TDM, SIP/IAX/H323 protocol, G711/G729 Codec). One of ordinary skill in the art would appreciate that there are numerous communications means that could be utilized with embodiments of the present invention, and embodiments of the present invention are contemplated for use with any communications means. Applications in application server 201 may also be used to manipulate information stored remotely and process and analyze data stored remotely across a WAN 206 (e.g., the Internet). The various servers (i.e., application server 201, database server 202, storage server 203 and web server 204) may be operatively connected via one or more connection means (e.g., network devices 205, cable connections, wireless connections). In other embodiments the various servers may be situated on a single multi-purpose machine (e.g., enterprise server) with each component being communicatively connected within the single multi-purpose machine. One of ordinary skill in the art would appreciate that there are numerous manners and methods for connecting the various components of the present invention, and embodiments of the present invention are contemplated for use with any manner or method of connecting the various components.

According to an exemplary embodiment, as shown in FIG. 2, exchange of information through the WAN 206 or other network may occur through one or more high speed connections. In some cases, high speed connections may be over-the-air (OTA), passed through networked systems, directly connected to one or more WANs 206 or directed through one or more network devices 205. Network devices 205 are completely optional and other embodiments in accordance with the present invention may or may not utilize one or more network devices 205. One of ordinary skill in the art would appreciate that there are numerous ways application server 201 may connect to WAN 206 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to application server 201 via WAN 206 or other networks and network devices 205 in numerous ways. For instance, a user may connect to the system through a user device 207 directly connected to the WAN 206, ii) through a computing device 207, through a network device (not shown), or iii) through a computing device 207 connected to a wireless access point (not shown). One of ordinary skill in the art would appreciate that there are numerous ways that a component may connect to application server 201 via WAN 206 or other network, and embodiments of the present invention are contemplated for use with any method for connecting to application server 201 via WAN 206 or other network. Furthermore, application server 201 could be comprised of a personal computing device, such as a smartphone, acting as a host for other computing devices to connect to.

In a preferred embodiment, for the purpose of providing automated trunk switching (i.e., switching of the call trunks is processed automatically when requested by a user) methods to users, a user may be able to connect to the application server 201 via a user device 207 comprising a telephony device. Telephony devices include, but are not limited to, landline telephones, cellular telephones, smartphones, and voice over IP (VOIP) means (e.g., VOIP phones, VOIP via a computing device). One of ordinary skill in the art would appreciate that there are numerous types of telephony devices that may be utilized with embodiments of the present invention, and embodiments of the present invention are contemplated for use with any type of telephony device. Connections to the application server 201 by a telephony device may be via a wireless connection means (e.g., CDMA, GMS, 3G, 4G), via a wired connection means (e.g., phone line, Ethernet) or any combination thereof.

According to an embodiment of the present invention, the system and methods described herein provide users the ability to switch between call trunks based on one or more criteria. In preferred embodiments of the present invention, the switching between call trunks allows for users to identify a specific call trunk with the highest level of QoS, or at least a specific call trunk with a QoS that exceeds the level of call quality desired by the user. In one embodiment, the call trunks are switched in series based on the Lowest Buy Rate trunks one at a time and loop back to the first Trunk that was used initially.

According to an embodiment of the present invention, in order to allow for the switching of call trunks by the user, a system must have access to a plurality of call trunks. Call trunks may be provided by third party providers, such as telecommunication companies, phone companies and other data and/or voice providers. One of ordinary skill in the art would appreciate that there are numerous third party providers of call trunks, and embodiments of the present invention are contemplated for use with any number of third party providers of call trunks.

According to an embodiment of the present invention, the system is configured to utilize a loopback method, based on least-call routing (LCR) and priority routing technology, available via a softswitch or hardware based PBX telephony switch, in order to affect the switching between call trunks in order to improve QoS. In a preferred embodiment, the user may be able to engage the switching of the call trunk via inputting a command into their communications device, such as entering a non-standard tone code including an asterisk (*) or hash (#) buttons. In other embodiments, the non-standard tone code could be any non-standard combination of tones. Further, in certain embodiments, the non-standard tone code could be replaced or used in conjunction with voice recognition features, such as the detection of a non-standard word combination used to engage the system. In general non-standard word combinations are those which do not occur in ordinary speech (e.g., “Safari Ocean”, “Jump Purple”). In other embodiment recitation of a non-standard code, such as a combination of words or numbers could be utilized. In still further embodiments, a combination of non-standard tone codes and non-standard word combinations could be used in conjunction with one another.

In a preferred embodiment, entrance of an initial non-standard tone code will end a first Call Trunk, then when the user enters a second non-standard tone code, the system will switch to a next available Call Trunk based on the system's preferred method set in advance (e.g., use lowest Buy Rate Call Trunk as the first call, followed by the next higher Buy Rate from the list of Call Trunks in the LCR system). In other embodiments, the system may be configured to automatically detect low QoS call trunks via one or means, such as static detection, signal strength, or other means, and avoid utilization of those low QoS call trunks. Detection of QoS by the system may be done at any time, such as prior to connecting a call or during a call (e.g., to allow for monitoring of QoS). One method for automatically detecting QoS of a call trunk prior to connecting a call is to have the system connect to a test phone number using the specified call trunk (e.g., via robotic dialing) and determine whether the call quality and connection time are above some threshold the system has identified as required for and/or appropriate for a voice call. In a preferred embodiment, the test phone number would be as proximate in location to the call recipient the user is attempting to contact in order to have the best analysis of the call trunk and local connection quality. Once a QoS level has been established, the system can then use the QoS level to further sort the available call trunks on this QoS level. One of ordinary skill in the art would appreciate that there are numerous variations of the above identified method for determining QoS level, and embodiments of the present invention are contemplated for use with any appropriate method for determining QoS level.

According to an embodiment of the present invention, the system may be configured to ensure that for any given call made by a user, the system does not retry a call trunk previously attempted and identified with a low QoS. In this manner, the system can eliminate reconnecting a user to a low QoS call trunk. Further, the system may be configured to record historical QoS levels, both subjectively (e.g., those call trunks utilized by users most frequently, implicitly denoting strong QoS) and objectively (e.g., those call trunks determined by the system to have strong QoS based on testing or empirical data).

According to an embodiment of the present invention, the system may be configured to loop through one or more available call trunks in order to allow a user to find one with an acceptable level of QoS. The system may further be configured to sort the available call trunks on various criteria prior to allowing the user to loop through them. For instance, the system may first sort the available call trunks based on LCR or other criteria (e.g., historical QoS levels between user and destination number). One of ordinary skill in the art would appreciate that there are numerous types of criteria for which the system could sort the available call trunks on, and embodiments of the present invention are contemplated for use with any such criteria.

### Exemplary Embodiment

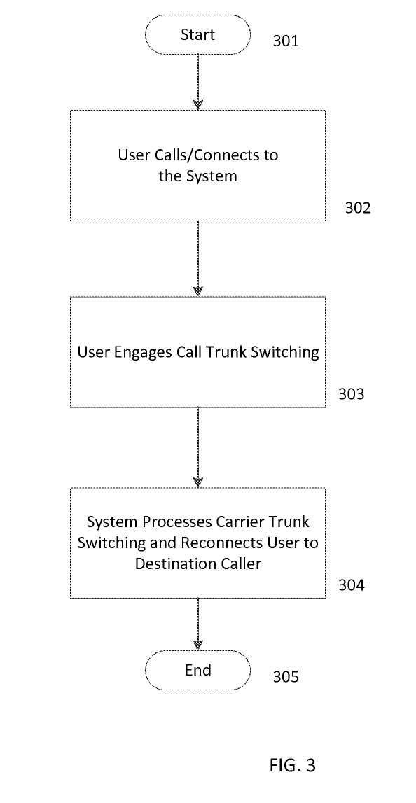

Turning now to FIG. 3, an exemplary method, in accordance with an embodiment of the present invention is shown. The process starts at step 300 with a user desiring to make a call to a destination number. In step 301, a user will call or otherwise connect to the system in order to make a call to a destination number. In a preferred embodiment, this call will be via a national phone number that is a local or otherwise toll-free call for the user.

In step 302, the user has been connected to the destination number, but the QoS of the first utilized call trunk (generally the one with the lowest-cost to the system) is subpar or otherwise unacceptable. The user then engages the call trunk switching method of the system via entering a command to the system (e.g., such as pressing “*#”).

At step 303, the system has received the request for call trunk switching. The system will then note the call trunk currently utilized (i.e., the low QoS Trunk). The system will then retrieve its list of available call trunks, exclude the low QoS Trunk and connect the user to the destination number via a different QoS Trunk. This process may be repeated, with each low QoS Trunk being noted and excluded from later connections by the user for the present call. If the customer loops through all available call trunks, the system may be configured to start the process over again by re-including each of the previously excluded low QoS Trunks in hopes that the QoS has improved in the interim.

At step 304, the user has identified a call trunk with an acceptable level of QoS and the process ends.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing automated trunk switching for quality of service improvement, said system comprising:
a trunk switching module, comprising computer-executable code stored in non-volatile memory,
a processor, and
a communication means,
wherein said trunk switching module, said processor, and said communication means are operably connected and are configured to:
provide access a user with access to a voice communication system, wherein said voice communication system has access to a plurality of call trunks;
connect a phone call of a user to a destination number via a first call trunk selected from said plurality of call trunks;
receive a call trunk switch command from said user;
retrieve a list of available call trunks, wherein said list of available call trunks are others of said plurality of call trunks that are available to transmit said phone call; and
connect said user to said destination number via a second call trunk.

2. The system of claim 1, wherein a loopback method is used to retrieve said list of available call trunks and each of said plurality of call trunks are attempted one at a time until arriving back at said first call trunk.

3. The system of claim 1, wherein said trunk switching module, said processor, and said communication means are operably connected and are further configured to:
detect said quality of service on each of said plurality of call trunks by monitoring each call trunk for one or more of static and signal strength;
determine whether each of said plurality of call trunks is above a quality of service threshold; and
upon determining that said quality of service for one of said plurality of call trunks is below said quality of service threshold, excluding each of said plurality of call trunks that are below said quality of service threshold from said list of available call trunks.

4. The system of claim 3, wherein said quality of service for a selected call trunk is detected prior to connecting said phone call to said destination number by connecting to a test phone number using said selected call trunk.

5. The system of claim 1, wherein said trunk switching module, said processor, and said communication means are operably connected and are further configured to record historical quality of service levels for each of said plurality of call trunks to determine a preferred list of call trunks.

6. The system of claim 1, wherein said call trunk switch command is a non-standard tone entered by said user.

7. The system of claim 6, wherein said non-standard tone is selected from a group of non-standard tones comprised of asterisk button tones, hash button tones, and combination tones.

8. The system of claim 1, wherein said call trunk switch command is a voice command.

9. The system of claim 8, wherein said voice command is a non-standard word combination.

10. A method for providing automated trunk switching for quality of service improvement, said method comprising the steps of:
providing access a user with access to a voice communication system, wherein said voice communication system has access to a plurality of call trunks;
connecting a phone call of a user to a destination number via a first call trunk selected from said plurality of call trunks;
receiving a call trunk switch command from said user;
retrieving a list of available call trunks, wherein said list of available call trunks are others of said plurality of call trunks that are available to transmit said phone call; and
connecting said user to said destination number via a second call trunk.

11. The method of claim 10, wherein a loopback method is used to retrieve said list of available call trunks and each of said plurality of call trunks are attempted one at a time until arriving back at said first call trunk.

12. The method of claim 10, further comprising the steps of:
detecting said quality of service on each of said plurality of call trunks by monitoring each call trunk for one or more of static and signal strength;
determining whether each of said plurality of call trunks is above a quality of service threshold; and
upon determining that said quality of service for one of said plurality of call trunks is below said quality of service threshold, excluding each of said plurality of call trunks that are below said quality of service threshold from said list of available call trunks.

13. The method of claim 12, wherein said quality of service for a selected call trunk is detected prior to connecting said phone call to said destination number by connecting to a test phone number using said selected call trunk.

14. The method of claim 10, further comprising the step of recording historical quality of service levels for each of said plurality of call trunks to determine a preferred list of call trunks.

15. The method of claim 10, wherein said call trunk switch command is a non-standard tone entered by said user.

16. The method of claim 15, wherein said non-standard tone is selected from a group of non-standard tones comprised of asterisk button tones, hash button tones, and combination tones.

17. The method of claim 10, wherein said call trunk switch command is a voice command.

18. The method of claim 17, wherein said voice command is a non-standard word combination.
